(19) United States
(12) Patent Application Publication
(10) Pub. No.: US 2022/0383151 A1
(43) Pub. Date: Dec. 1, 2022

(54) STEERING OF ROAMING OPTIMIZATION WITH SUBSCRIBER BEHAVIOR PREDICTION

(71) Applicants: AT&T Intellectual Property I, L.P., Atlanta, GA (US); AT&T Mobility II LLC, Atlanta, GA (US)

(72) Inventors: Yukun Zeng, McKinney, TX (US); Prince Paulraj, Coppell, TX (US); Sherri Rogers, Snohomish, WA (US); Scott Alexander, Dallas, TX (US); Shilpi Harpavat, Dallas, TX (US); Shreyash Taywade, Plano, TX (US); Aubryn Lewis, Sammamish, WA (US); Cameron Dunn, Castle Pines, CO (US); Sandeep David Golkonda, McKinney, TX (US); Roli Arora, Frisco, TX (US)

(73) Assignees: AT&T Intellectual Property I, L.P., Atlanta, GA (US); AT&T Mobility II LLC, Atlanta, GA (US)

(21) Appl. No.: 17/331,225

(22) Filed: May 26, 2021

(51) Int. Cl. G06N 5/04; H04W 4/24; H04W 24/08; G06N 20/00

(52) U.S. Cl. CPC G06N 5/04; H04W 4/24; H04W 24/08; G06N 20/00

(57) ABSTRACT

Aspects of the subject disclosure may include, for example, obtaining roaming agreement data related to roaming agreements that are between a wireless provider and a respective one of a plurality of wireless roaming providers; obtaining, for each wireless subscriber of the wireless provider, respective roaming usage data, all of the respective roaming usage data comprising collective roaming usage data; training, based upon the collective roaming usage data, a set of one or more models, the one or more models comprising one or more statistical models, one or more machine learning models, or any combination thereof, the one or more models being trained with multiple iterations of feedback loops, and the training resulting in one or more trained models; estimating for each wireless subscriber, based upon the one or more trained models, respective projected location information for a future time, all of the respective projected location information comprising collective projected location information; obtaining, for each of a plurality of wireless coverage areas of the plurality of wireless roaming providers, respective real-time network quality measurement data, all of the respective real-time network quality measurement data comprising collective real-time network quality measurement data; modeling a plurality of scenarios for the future time based upon the roaming agreement data, based upon the collective real-time network quality measurement data and based upon the collective projected location information, each of the scenarios identifying for each of a plurality of projected future wireless roaming subscribers a respective one of the wireless roaming providers to communicate with at the future time, each of the scenarios further identifying a respective cost to the wireless provider, and the modeling being performed via use of a plurality of model constraints; selecting from the scenarios, as a selected scenario, a scenario that has associated therewith a lowest total cost to the wireless provider also satisfying one or more of the plurality of model constraints based upon the collective roaming agreement data; and sending recommendations, to a plurality of steering mechanisms, in order to implement the selected scenario. Other embodiments are disclosed.

### FIELD OF THE DISCLOSURE

The subject disclosure relates to steering of roaming optimization with subscriber behavior prediction. One specific example relates to real-time steering of roaming optimization with subscriber behavior prediction.

### BACKGROUND

Roaming refers to the behavior of connecting to other available networks when a mobile device is out of range of its home network. A mobile network provider (or carrier) typically enters into agreements with other carriers across different geographical regions of the world, in order to ensure that their own customers have access to mobile service while traveling outside their home network. Typically, a given mobile network carrier will sign multiple roaming agreements with different local carriers; thus, a steering strategy would need to be in place to select the appropriate local carrier for serving each of the roaming subscribers. The terms of these roaming agreements can be complex and multi-faceted, with bilateral business targets and/or commitments in terms of wholesale revenue, market share, ratios of usage types, and many other various terms and conditions.

Further, network traffic steering is a significant part of a mobile carrier's roaming strategy, where all roaming subscribers are directed/distributed to multiple available networks with various considerations such as carrier and user preferences, network Quality of Service (QoS), device compatibility, and wholesale and retail pricing. Many carriers have implemented a steering platform (or steering selection platform) which allows them to direct their customers to a specific roaming network based on preferred settings (usually percentage-based), in addition to pure network signal strength. Most conventional steering selection platforms are static, requiring users of the steering selection platform (e.g., employees of the mobile carrier) to manually set-up and maintain steering rules based on the needs of the business and/or based on technical, network or political situations. These manually implemented static steering rules (which typically adopt static carrier-level network quality ratings/preferences with regard to considerations of roaming user experiences) often lead to suboptimal governance in many different perspectives such as user experience, business and financial targets, etc.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system in accordance with various aspects described herein.

FIG. 2B is a block diagram illustrating an example, non-limiting embodiment of a system in accordance with various aspects described herein.

FIG. 2C is a block diagram illustrating an example, non-limiting embodiment of a system in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 2F depicts an illustrative embodiment of a method in accordance with various aspects described herein.

FIG. 2G is a block diagram illustrating an example, non-limiting embodiment of a system in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for steering of a roaming mobile communication device to a selected roaming network. Other embodiments are described in the subject disclosure.

One or more aspects of the subject disclosure include a mechanism to steer each of a plurality of mobile communication devices (e.g., smartphones, tablets, cell phones or the like) to a respective target roaming network that is selected from among a plurality of candidate roaming networks.

One or more aspects of the subject disclosure include a platform (e.g., a software implementation, an algorithm, or the like) that provides for real-time data ingestion, digestion, and integration of disparate roaming-related data (such as obtained from disparate roaming-related data sources). The roaming-related data (and/or roaming-related data sources) can include (but are not limited to): (a) roaming agreements (or contracts); (b) anonymized subscriber roaming usage data; (c) network quality of service (QoS) metrics and key performance indicators (KPIs); (d) any combination thereof.

In various examples, scanned contracts can be parsed via an information extraction platform that uses Optical Character Recognition (OCR) and artificial intelligence (AI) technologies to recognize and extract contract terms and conditions (T&Cs).

In various examples, the subscriber roaming usage data can include (but not be limited to): (a) demographic patterns; (b) historical subscriber usage patterns; (c) historical subscriber travel patterns; (d) any combination thereof.

As described herein, various embodiments can provide a novel forecast model ensembling multiple state of the art machine learning algorithms (e.g., PROPHET, GBM, XGBOOST) and advanced AI technologies, such as supervised/unsupervised machine learning and sequence-to-sequence modeling. In various embodiments, these models can be used for different spatial granularity levels, and further tuned with AutoML hyperparameter searching technologies (e.g., Bayesian optimization, grid search). Additionally, these models can be domain agnostic, allowing for quick deployment across any telecommunications provider. In various embodiments, these models allow the platform to learn changing usage patterns across the globe and allow the forecasts to be shifted rapidly in emergency situations (such as in the current worldwide COVID-19 pandemic scenario).

As described herein, various embodiments provide a fully-automatic dynamic AI-driven platform, which: 1) constantly captures and forecasts anonymized subscriber roaming behaviors across the world based on ensembled machine learning algorithms with automatic hyperparameter tuning; 2) uses multi-objective optimization methods to distribute roaming customers to worldwide carriers in real-time for minimized wholesale costs, improved user experience, and to meet network quality targets; 3) provides multiple workflow approval processes, with network element connectivity for near real-time implementation of steering recommendations made by the machine learning models; and/or 4) produces contract performance analytics for short and long-term business strategy adjustment and transformation (e.g., for the various roaming management teams and executive management).

As described herein, various embodiments can provide a dynamic steering system. Such a dynamic steering system according to various embodiments can provide (or help to provide) satisfactory user roaming experience under constantly changing network conditions while meeting business targets across worldwide markets.

As described herein, various embodiments can provide steering recommendations/instructions that are based on projected subscriber-level roaming behaviors and usage forecasts. Multiple constraint optimization models can be applied and integrated with various existing network data sources to make steering decisions that guarantee user experience quality while meeting business targets, with minimized wholesale costs, while taking into account carriers sharing contract terms across multiple countries. The output of these optimization models can provide dynamic steering recommendations/instructions and allow for full automation and integration, with real-time (or near real-time) implementations, through direct network element connectivity and massive over the air (OTA) updates/pushes. Various embodiments can also provide for quality-based steering changes, which further allow for timely implementation under emergency scenarios and situations, such as when network issues (e.g., outages) occur. Various embodiments can also provide several real-time (or near real-time) dashboard views, which allow for additional tracking of contract commitments and modeling of different steering solutions, to compare attributes such as cost and network quality, and potentially facilitate use this information for negotiation of new roaming agreements. Various embodiments can also provide other reports and tools for comparison between multiple data sources for validation of implemented configurations and steering changes. Various embodiments can also provide (e.g., for auditing purposes) mechanisms wherein the automated steering decisions and implementations can be tracked along with periodic contract performance measurements. Various embodiments can also provide for analysis of these data points (wherein the analysis can be used, for example, by various roaming management teams to generate insights towards future contract negotiations).

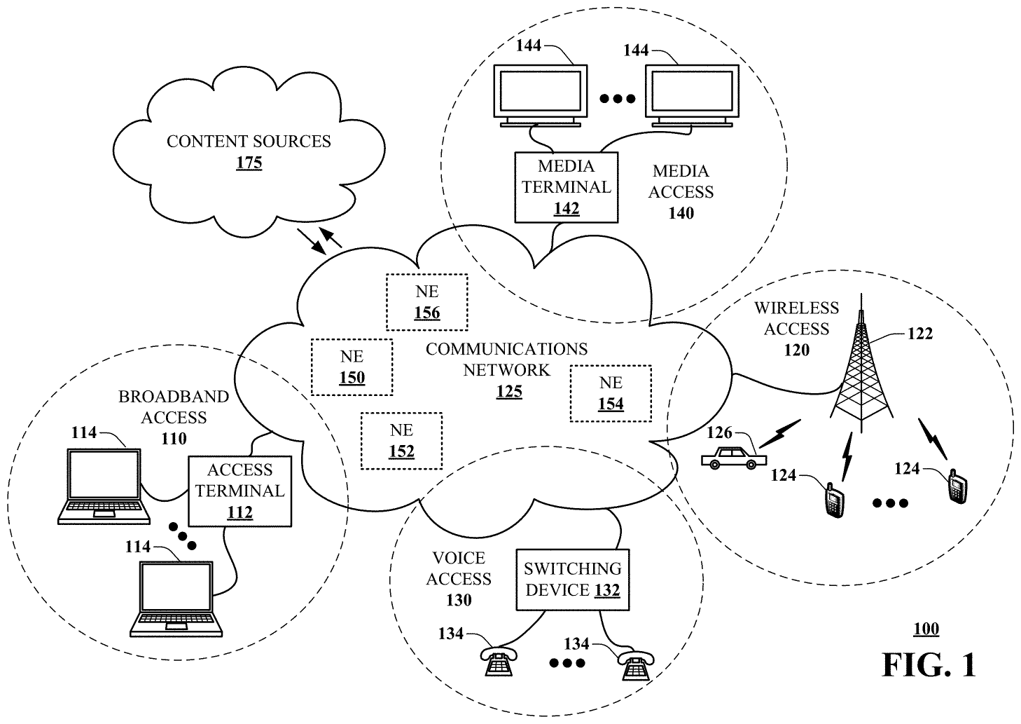

Referring now to FIG. 1, a block diagram is shown illustrating an example, non-limiting embodiment of a system 100 in accordance with various aspects described herein. For example, system 100 can facilitate in whole or in part steering each of a plurality of mobile communication devices (e.g., smartphones, tablets or the like) to a respective target roaming network that is selected from a plurality of candidate roaming networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

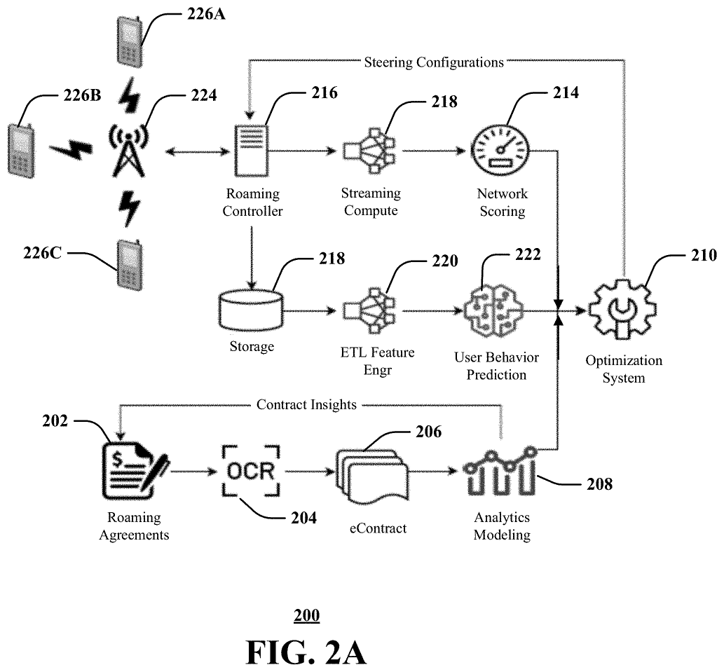

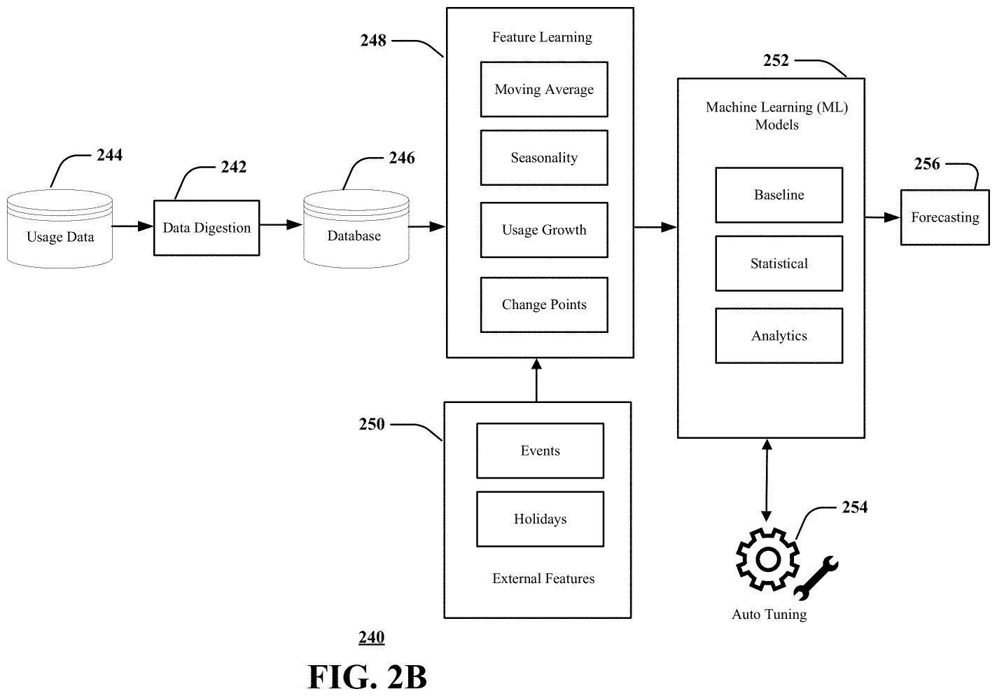

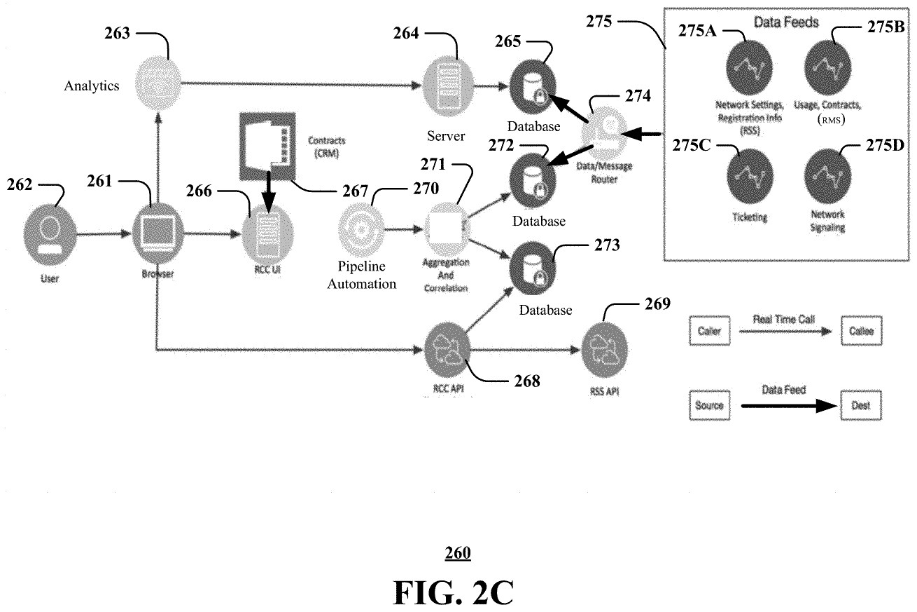

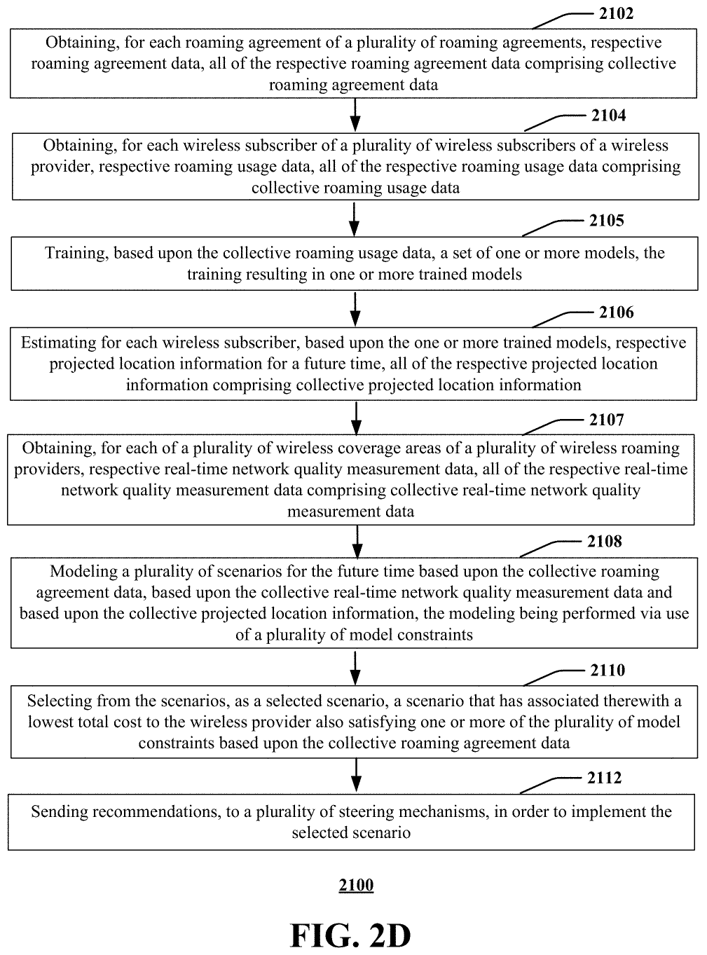

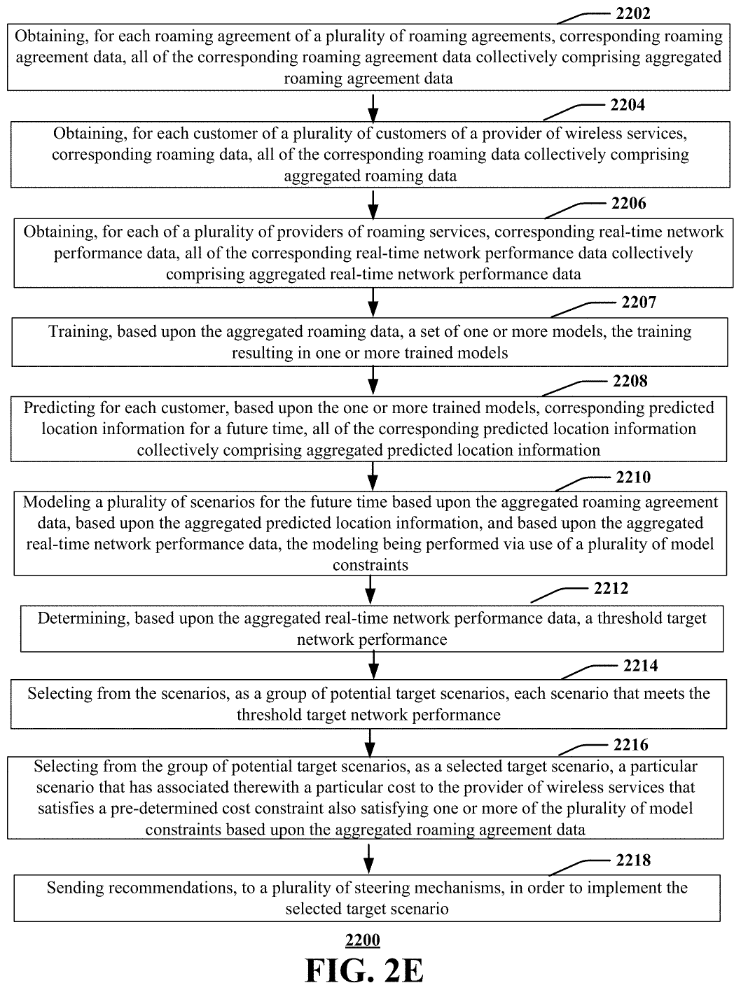

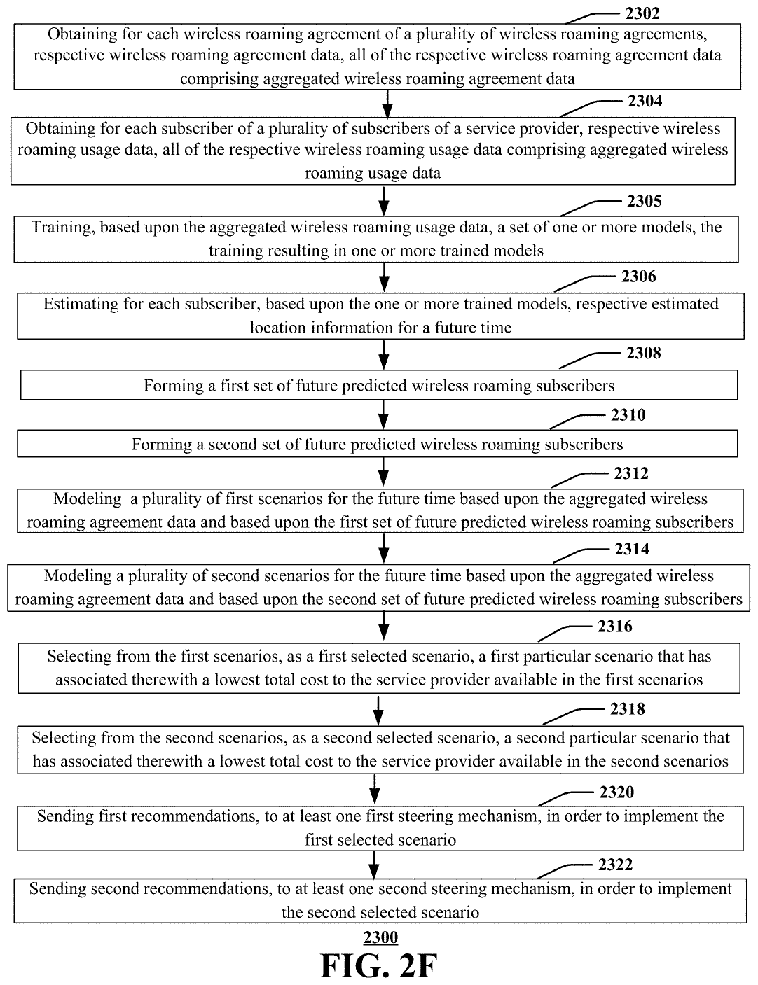

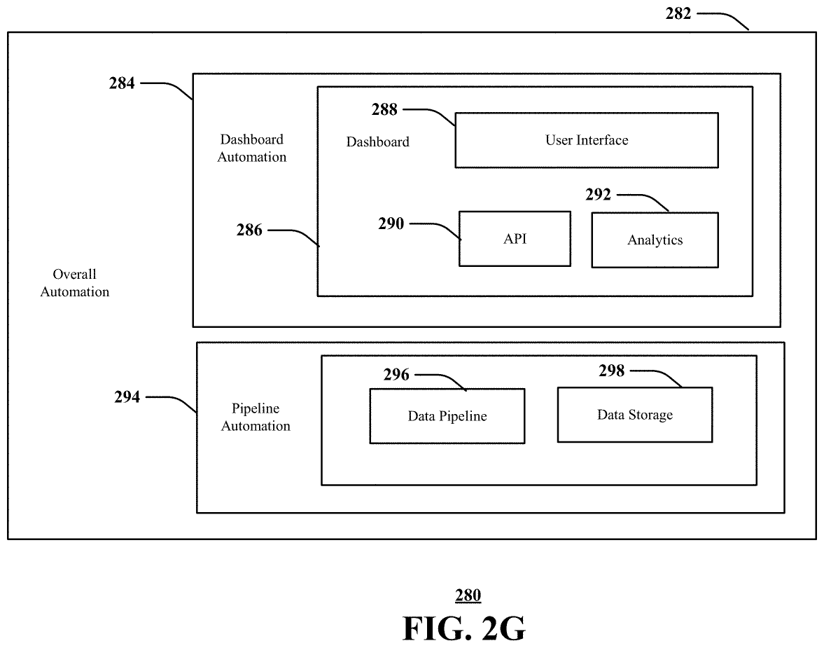

Referring now to FIG. 2A, depicted is a block diagram illustrating an example, non-limiting embodiment of a system 200 (which can function, for example, within, associated with, or independently of the communication network of FIG. 1) in accordance with various aspects described herein. As seen in this figure, Roaming Agreements 202 can undergo optical character recognition (OCR) 204 to be formatted as eContracts 206. The eContracts 206 can be applied to Analytics Modeling 208 (that is, one or more software components or the like to perform analytics modeling). An output of Analytics Modeling 208 can be sent as an input to Optimization System 210 (which can use the data from Analytics Modeling 208 to facilitate generation of steering recommendations and/or instructions as described herein). In addition, output from User Behavior Prediction 222 (that is, one or more software components or the like to perform user behavior prediction) can be sent as input to Optimization System 210 (which can use the data from User Behavior Prediction 222 to facilitate generation of steering recommendations and/or instructions as described herein). Further, output from Network Scoring 214 (that is, one or more software components or the like to perform network scoring) can be sent as input to Optimization System 210 (which can use the data from Network Scoring 214 to facilitate generation of steering recommendations and/or instructions as described herein).

Still referring to FIG. 2A, steering recommendations and/or instructions (e.g., in the form of steering configurations) can be sent from Optimization System 210 to Roaming Controller 216 (which can use the steering configurations from Optimization System 210 to facilitate generation of steering recommendations and/or instructions as described herein). Further, feedback can be sent to Network Scoring 214 from Roaming Controller 216 via Streaming Compute 218 (that is, one or more software components or the like to perform various computations). Further still, feedback can be sent to Storage 218 from Roaming Controller 216. Moreover, data (e.g., including feedback from Roaming Controller 216) can be sent from Storage 218 to User Behavior Prediction 222 via ETL (Extract Transform Load) Feature Engr 220. In various examples, the Extract Transform Load can be used to move data from one location to another. In various examples, each of the data sources that represent information from the various network elements/controllers can be provided as input into the Roaming Command Center (RCC). In various examples, this can be to determine the “current state” of settings and/or to identify suggested changes to those elements/controllers (for instance, going from 10% to 10% isn't really a change, it's status quo; various mechanisms can be configured such that only when a change is necessary is an action kicked off).

Still referring to FIG. 2A, Roaming Controller 216 can be in bi-directional communication with Wireless Communication Element 224 (which can be, for example, a base station, a switch, a steering mechanism, or any combination thereof). Wireless Communication Element 224, in turn, can be in bi-directional communication with each of mobile devices 226A, 226B, 226C. In various examples, each of the mobile devices 226A, 226B, 226C can be a smartphone, a tablet, a laptop computer, a cell phone, or any combination thereof. The bi-directional communication between Roaming Controller 216 and Wireless Communication Element 224 can enable: (a) the sending by Roaming Controller 216 to Wireless Communication Element 224 of steering recommendations and/or instructions as described herein; and (b) the receiving by Roaming Controller 216 from Wireless Communication Element 224 of feedback (such as network performance metrics) as described herein.

Referring now to FIG. 2B, depicted is a block diagram illustrating an example, non-limiting embodiment of a system 240 (which can function, for example, within, associated with, or independently of one or more of the communication network of FIG. 1 and/or the system of FIG. 2A) in accordance with various aspects described herein. As seen in this figure, system 240 can include Data Digestion 242 (that is, one or more software components or the like to receive data). Data Digestion 242 can receive Usage Data 244 and then output processed data to Database 246. Further, Feature Learning 248 (that is, one or more software components or the like to perform feature learning) can receive data from Database 246. Feature Learning 248 can also receive External Features (see element 250). The Eternal Features 250 can include, for example, one or more events and/or one or more holidays).

Still referring to FIG. 2B, it is seen that Feature Learning 248 can include Moving Average, Seasonality, Usage Growth, and Change Points. Further, it is seen that output from Feature Learning 248 can be sent to Machine Learning (ML) Models 252. Machine Learning (ML) Models 252 can include Baseline, Statistical, and Analytics. Machine Learning (ML) Models 252 can also be in bi-directional communication with Auto Tuning 254 (that is, one or more software components or the like to perform automatic tuning). Moreover, output from Machine Learning (ML) Models 252 can be sent to Forecasting 256 (that is, one or more software components or the like to perform forecasting). The Forecasting 256 can be directed, for example, to steering decisions for wireless roaming as described herein.

Referring now to FIG. 2C, depicted is a block diagram illustrating an example, non-limiting embodiment of a system 260 (which can function, for example, within, associated with, or independently of one or more of the communication network of FIG. 1 and/or the system of FIG. 2A) in accordance with various aspects described herein. As seen in this figure, system 260 can include a Browser 261 that receives input from User 262 (Browser 261 can receive input from User 262 and/or from equipment being operated by User 262). Browser 261 can be in operative communication with Analytics 263, which in turn can be in operative communication with Server 264, which in turn can be in operative communication with Database 265.

Still referring to FIG. 2C, Browser 261 can be in operative communication with Roaming Command Center User Interface (RCC UI) 266, which can also receive contract data from CRM (Customer Relationship Management) 267. Browser 261 can also be in operative communication with Roaming Command Center (RCC) API (Application Programming Interface) 268, which in turn can be in operative communication with RSS/vRSS (Roamer Selection Service/virtual Roamer Selection Service) API 269. The RSS/vRSS is an application through which roaming/steering changes can be submitted. Further, Pipeline Automation 270 can be in operative communication with Aggregation and Correlation 271. Further still, Aggregation and Correlation 271 can be in operative communication with Database 272 and Database 273. Database 273 can also be in operative communication with Roaming Command Center (RCC) API 268. Further still, Data/Message Router 274 can be in operative communication with Database 265 and Database 272. Data/Message Router 274 can receive Data Feeds 275. Data Feeds 275 can include: Network Settings, Registration Information 275A (e.g., from an RSS/vRSS); Usage, Contracts 275B (e.g., from a ticketing system for roaming-related outages and/or from an RMS, or Roamer Management System (an application that can control (e.g., can control a majority of) various roaming partner information)); Ticketing 275C (e.g., from a mobility-related ticketing system); and Network Signaling 275D.

Still referring to FIG. 2C, in this example, all of the communications between the various components (except those communications involving Data/Message Router 274 and CRM 267) can be real-time calls (between caller and callee). These real-time calls are shown in the figure with lighter-weight arrows. The communications from the Data Feeds 275 to Data/Message Router 274, the communications from Data/Message Router 274 to Database 265 and Database 272, and the communications from CRM 267 to RCC UI 266 can be data feeds. These data feeds are shown in the figure with heavier-weight arrows.

Referring now to FIG. 2D, various steps of a method 2100 according to an embodiment are shown. As seen in this FIG. 2D, step 2102 comprises obtaining, for each roaming agreement of a plurality of roaming agreements, respective roaming agreement data, each roaming agreement being between a wireless provider and a respective one of a plurality of wireless roaming providers, and all of the respective roaming agreement data comprising collective roaming agreement data. Next, step 2104 comprises obtaining, for each wireless subscriber of a plurality of wireless subscribers of the wireless provider, respective roaming usage data, the roaming usage data of each wireless subscriber comprising respective historical location information, and all of the respective roaming usage data comprising collective roaming usage data. Next, step 2105 comprises training, based upon the collective roaming usage data, a set of one or more models, the one or more models comprising one or more statistical models, one or more machine learning models, or any combination thereof, the one or more models being trained with multiple iterations of feedback loops, and the training resulting in one or more trained models. Next, step 2106 comprises estimating for each wireless subscriber, based upon the one or more trained models, respective projected location information for a future time, all of the respective projected location information comprising collective projected location information. Next, step 2107 comprises obtaining, for each of a plurality of wireless coverage areas of the plurality of wireless roaming providers, respective real-time network quality measurement data, all of the respective real-time network quality measurement data comprising collective real-time network quality measurement data. Next, step 2108 comprises modeling a plurality of scenarios for the future time based upon the collective roaming agreement data, based upon the collective real-time network quality measurement data and based upon the collective projected location information, each of the scenarios identifying for each of a plurality of projected future wireless roaming subscribers a respective one of the wireless roaming providers to communicate with at the future time, each of the scenarios further identifying a respective cost to the wireless provider and the modeling being performed via use of a plurality of model constraints. Next, step 2110 comprises selecting from the scenarios, as a selected scenario, a scenario that has associated therewith a lowest total cost to the wireless provider also satisfying one or more of the plurality of model constraints based upon the collective roaming agreement data. Next, step 2112 comprises sending recommendations, to a plurality of steering mechanisms, in order to implement the selected scenario, each of the recommendations causing a respective one of the steering mechanisms to direct respective equipment associated with each of the projected future wireless roaming subscribers to communicate with a particular one of the wireless roaming providers identified in the selected scenario for that projected future wireless roaming subscriber. In various examples, the modeling is performed in real-time and the modeling is performed using machine-learning. In various examples, the training is by one or more distributed computer systems. In various examples, the one or more models are trained with multiple iterations of feedback loops. In various examples, the training comprises automated parameter selection that is applied during the training for improved accuracy. In various examples, the method further comprises: monitoring the collective real-time network quality measurement data for steered subscribers based upon each of their latest locations, and readjusting steering configurations to select backup scenario(s) in event of one or more sudden network quality drops (e.g., when network quality fell below expectation) due, for example, to subscriber movements and/or network emergencies.

In one example, the respective equipment associated with each of the projected future wireless roaming subscribers comprises one of: a smartphone; a tablet; a laptop computer; a cell phone; or any combination thereof.

In one example, one or more of the projected future wireless roaming subscribers is a same subscriber as one or more of the wireless subscribers.

In one example, each of the projected future wireless roaming subscribers is a same subscriber as a respective one of each of the wireless subscribers.

In one example, each of the projected future wireless roaming subscribers is different from each of the wireless subscribers.

In one example, the sending the recommendations comprises sending a respective recommendation to each respective one of the steering mechanisms, and wherein each recommendation differs from each other recommendation.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2200 according to an embodiment are shown. As seen in this FIG. 2E, step 2202 comprises obtaining, for each roaming agreement of a plurality of roaming agreements, corresponding roaming agreement data, each roaming agreement being between a provider of wireless services and a respective one of a plurality of providers of roaming services, and all of the corresponding roaming agreement data collectively comprising aggregated roaming agreement data. Next, step 2204 comprises obtaining, for each customer of a plurality of customers of the provider of wireless services, corresponding roaming data, the roaming data of each customer comprising corresponding location information indicative of one or more locations at which that customer had utilized corresponding wireless communication equipment, and all of the corresponding roaming data collectively comprising aggregated roaming data. Next, step 2206 comprises obtaining, for each of the providers of roaming services, corresponding real-time network performance data, all of the corresponding real-time network performance data collectively comprising aggregated real-time network performance data. Next, step 2207 comprises training, based upon the aggregated roaming data, a set of one or more models, the one or more models comprising one or more statistical models, one or more machine learning models, or any combination thereof, the one or more models being trained with multiple iterations of feedback loops, and the training resulting in one or more trained models. Next, step 2208 comprises predicting for each customer, based upon the one or more trained models, corresponding predicted location information for a future time, all of the corresponding predicted location information collectively comprising aggregated predicted location information. Next, step 2210 comprises modeling a plurality of scenarios for the future time based upon the aggregated roaming agreement data, based upon the aggregated predicted location information, and based upon the aggregated real-time network performance data, each of the scenarios identifying for each of a plurality of projected future roaming customers a corresponding one of the providers of roaming services to communicate with at the future time, each of the scenarios further identifying a corresponding total cost to the provider of wireless services, each of the scenarios further identifying an estimated network performance, and the modeling being performed via use of a plurality of model constraints. Next, step 2212 comprises determining, based upon the aggregated real-time network performance data, a threshold target network performance. Next, step 2214 comprises selecting from the scenarios, as a group of potential target scenarios, each scenario that meets the threshold target network performance. Next, step 2216 comprises selecting from the group of potential target scenarios, as a selected target scenario, a particular scenario that has associated therewith a particular cost to the provider of wireless services that satisfies a pre-determined cost constraint also satisfying one or more of the plurality of model constraints based upon the aggregated roaming agreement data. Next, step 2218 comprises sending recommendations, to a plurality of steering mechanisms, in order to implement the selected target scenario, the recommendations causing the steering mechanisms to direct a corresponding mobile device associated with each of the projected future roaming customers to communicate with a particular one of the providers of roaming services identified in the selected target scenario for that projected future roaming customer.

In one example, satisfying the pre-determined cost constraint can comprise being a lowest cost to the provider of wireless services. In another example, satisfying the pre-determined cost constraint can comprise being one among N number of costs forming a range of lower costs to the provider of wireless services, wherein N is an integer between 2 and 30 (inclusive). In one example, the selected target scenario can be selected based upon a combination of: (a) exceeding the threshold target network performance by a certain amount; and (b) the particular cost to the provider of wireless services being among the lowest (e.g., among the 3 lowest) costs to the provider of wireless services.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2F, various steps of a method 2300 according to an embodiment are shown. As seen in this FIG. 2F, step 2302 comprises obtaining by a processing system including a processor, for each wireless roaming agreement of a plurality of wireless roaming agreements, respective wireless roaming agreement data, each wireless roaming agreement being between a service provider and a respective one of a plurality of roaming providers, and all of the respective wireless roaming agreement data comprising aggregated wireless roaming agreement data. Next, step 2304 comprises obtaining by the processing system, for each subscriber of a plurality of subscribers of the service provider, respective wireless roaming usage data, the wireless roaming usage data of each subscriber comprising respective historical location information, and all of the respective wireless roaming usage data comprising aggregated wireless roaming usage data. Next, step 2305 comprises training by the processing system, based upon the aggregated wireless roaming usage data, a set of one or more models, the one or more models comprising one or more statistical models, one or more machine learning models, or any combination thereof, the one or more models being trained with multiple iterations of feedback loops, and the training resulting in one or more trained models. Next, step 2306 comprises estimating by the processing system for each subscriber, based upon the one or more trained models, respective estimated location information for a future time. Next, step 2308 comprises forming by the processing system a first set of future predicted wireless roaming subscribers, the first set of future predicted wireless roaming subscribers being based upon those subscribers whose respective estimated location information for the future time falls within a first region. Next, step 2310 comprises forming by the processing system a second set of future predicted wireless roaming subscribers, the second set of future predicted wireless roaming subscribers comprising those subscribers whose respective estimated location information for the future time falls within a second region, the second region being different from the first region. Next, step 2312 comprises modeling by the processing system a plurality of first scenarios for the future time based upon the aggregated roaming agreement data and based upon the first set of future predicted wireless roaming subscribers, each of the first scenarios identifying for each of the future predicted wireless roaming subscribers of the first set of future predicted wireless roaming subscribers a respective one of the roaming providers to communicate with at the future time, each of the first scenarios further identifying a respective first cost to the service provider. Next, step 2314 comprises modeling by the processing system a plurality of second scenarios for the future time based upon the aggregated roaming agreement data and based upon the second set of future predicted wireless roaming subscribers, each of the second scenarios identifying for each of the future predicted wireless roaming subscribers of the second set of future predicted wireless roaming subscribers a respective one of the roaming providers to communicate with at the future time, each of the second scenarios further identifying a respective second cost to the service provider. Next, step 2316 comprises selecting by the processing system from the first scenarios, as a first selected scenario, a first particular scenario that has associated therewith a lowest total cost to the service provider available in the first scenarios. Next, step 2318 comprises selecting by the processing system from the second scenarios, as a second selected scenario, a second particular scenario that has associated therewith a lowest total cost to the service provider available in the second scenarios. Next, step 2320 comprises sending by the processing system first recommendations, to at least one first steering mechanism, in order to implement the first selected scenario, the first recommendations causing the at least one first steering mechanism to direct respective equipment associated with each future predicted wireless roaming subscriber of the first set of future predicted wireless roaming subscribers to wirelessly communicate with a first particular one of the roaming providers identified in the first selected scenario for that future predicted wireless roaming subscriber. Next, step 2322 comprises sending by the processing system second recommendations, to at least one second steering mechanism, in order to implement the second selected scenario, the second recommendations causing the at least one second steering mechanism to direct respective equipment associated with each future predicted wireless roaming subscriber of the second set of future predicted wireless roaming subscribers to wirelessly communicate with a second particular one of the roaming providers identified in the second selected scenario for that future predicted wireless roaming subscriber.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2G, depicted is a block diagram illustrating an example, non-limiting embodiment of a system 280 (which can function, for example, within, associated with, or independently of one or more of the communication network of FIG. 1 and/or the system of FIG. 2A) in accordance with various aspects described herein. As seen in this figure, system 280 (which can be implemented, for example, as a Roaming Command Center) can include Overall Automation 282. Overall Automation 282 can include Dashboard Automation 284 and Pipeline Automation 294. Dashboard Automation 284 can include Dashboard 286 (which, in turn, can include User Interface 288, AI 290 and Analytics 292). Further, Pipeline Automation 294 can include Data Pipeline 296 and Data Storage 298.

As described herein, various embodiments can utilize segmentation and/or filtering (e.g., segmentation and/or filtering of various data). In one example, an entity (e.g., a wireless provider) can segment and/or filter data by traffic type. In another example, traffic type can be selected from: enterprise; internet of things (IoT); prepaid; consumer; or any combination thereof). In another example, an entity (e.g., a wireless provider) can apply different treatment to each of various portions of the segmented and/or filtered data (such as different treatment to different traffic types). In another example, an entity (e.g., a wireless provider) can segment and/or filter one or more of the following areas by traffic type: roaming contracts; data usage; forecasting; and/or traffic steering.

As described herein, various embodiments can implement a partner scorecard mechanism. In one example, under such a partner scorecard mechanism, an entity (e.g., a wireless provider) can evaluate and/or rate a respective network performance of one or more roaming partners (e.g., one or more wireless roaming providers that provide roaming services to subscribers of the wireless provider). In another example, traffic steering can be based upon: contract rates associated with one or more roaming partners; network performance associated with one or more roaming partners; or any combination thereof. In another example, data from one or more partner scorecards can be fed back into an algorithm and/or model for generating steering recommendations/instructions. In one example, data from the partner scorecard(s) can comprise data from one or more network signaling data feeds. In various examples, the data from the partner scorecard(s) can be utilized as follows: (a) apply scorecard ratings per roaming partner using network signaling performance and/or roaming trouble tickets; (b) feed scorecard ratings into the algorithm and/or model that generates steering recommendations/instructions; (c) enable selection by users (e.g., one or more employees of a wireless provider) of one or more algorithm decision criteria and/or model decision criteria; and/or (d) any combination of the above. In various examples, the algorithm decision criteria and/or model decision criteria can comprise: (a) cost only; (b) performance only; or (c) cost plus performance.

In various examples, the algorithm optimization constraints and/or model optimization constraints can comprise: (a) Country of the Carrier (e.g., country code/description); (b) Carrier Group; (c) Contract: Start/End dates; (d) Contract: # of Free Units; (e) Contract: Cost of Free Units; (f) Contract: % of Market; (g) Share Incollect; (h) Contract: $ of Revenue; (i) Contract: Bill & Keep $; (j) Contract: Balance Type; (k) Contract: Balance Collar %; (1) Contract: Balance Unit Cost; (m) Contract: Unit cost; (n) Data tiering rates; (o) Local currency (not USD) rates; (p) Billing “actual” versus “rounded” (mins and data); (q) Multiple Free Unit countries; (r) “Penalty Box” for cost of missing a commitment; (s) M2M (machine to machine); (t) Free units by service type; (u) Cross-country (e.g., ISR/PSE (Country codes for Israel and Palestine) and SMR/ITA (Country codes for San Marino and Italy)); (v) Cross-border (e.g., AT&T USA and AT&T Mexico) commitments; (w) Additional MOC (Mobile Originated Call) groups (e.g., calls to all-of-Europe instead of just ROW (Rest of World)); (x) MOC/MTC (Mobile Originated Call/Mobile Terminated Call) ratio; (y) MB/MOC (Megabyte/Mobile Originated Call) Ratio; and/or (z) any combination thereof. In various examples, one, more than one, or all of the above can be used as inputs to the constraint model.

As described herein, various embodiments can be used by one or more telecommunications companies (e.g., worldwide telecommunications companies) that utilize and/or provide roaming services.

As described herein, various embodiments can minimize the roaming-related wholesale expenses/costs that are currently accrued by companies (e.g., wireless carriers).

As described herein, dynamic steering (according to various embodiments) will likely become ever more important for cost minimization and guaranteed quality delivery (particularly as roaming wireless data usage continues to increase exponentially).

As described herein, various embodiments can provide service providers with benefits (such as an economic benefit from an optimized exploitation of their roaming agreements) while staying competitive in providing seamless high-quality roaming experiences and adjusting long-term roaming strategies. In one example, the model(s) and/or algorithm(s) can provide less than perfect economic optimization while also providing other benefit(s). For instance, the model(s) and/or algorithm(s) can provide somewhat improved economic benefit (e.g. selecting the 2^{nd} best or 3^{rd} best economic strategy) while simultaneously satisfying other constraint(s), such as one or more traffic constraints, etc. In various examples, cost is not the top consideration—for instance, the model can handle specific traffic requirements per carrier (e.g., averaged over the contract) and other situations.

As described herein, various embodiments can provide: improved roaming network quality; improved customer satisfaction; improved productivity in recovering from roaming network emergencies; reduced wholesale roaming costs; full automation of optimization; full automation of implementation of roaming steering; or any combination thereof. In various examples, a wireless service provider can accommodate (rather than control) a network quality of another provider (e.g., a roaming partner).

As described herein, various embodiments can provide steering recommendations and/or instructions that take into account historical information and that use automation and/or machine learning to make optimal recommendations and/or instructions.

As described herein, various embodiments can make real-time decisions based on correlated information between/among disparate data sets.

As described herein, various embodiments can provide a Roaming Command Center that uses feature learning to make a forecast of usage.

As described herein, various embodiments can receive feedback from one or more networks and then provide recommendations and/or instructions that alter how the network(s) perform.

As described herein, various embodiments can provide steering recommendations and/or instructions in the context of user segment forecasting. In one example, segmentation can be done by customer type (e.g., enterprise, consumer).

As described herein, various embodiments can make use of network signaling data. For example, network signaling data can be used in making a “scorecard”, in making future forecasts, and/or in making future recommendations and/or instructions.

As described herein, various embodiments can provide a platform that can be utilized to analyze how traffic should be steered.

As described herein, various embodiments can provide a global view of business targets and user experiences, as well as real-time situational awareness to adapt quickly to local network dynamics.

As described herein, various embodiments can provide steering recommendations and/or instructions to one or more steering mechanisms (such steering mechanisms can be, for example, in the form of one or more conventional steering selection platforms). The steering selection platforms can initially communicate (e.g., via default over-the-air (OTA) communications) with various mobile devices to implement the steering recommendations and/or instructions as described herein according to various embodiments.

As described herein, various embodiments can provide steering recommendations and/or instructions that override certain conventional configurations such as always prefer one carrier option or a set percentage split option.

As described herein, various embodiments can provide a steering recommendation for a particular carrier, wherein a steering selection platform that receives the recommendation makes a final determination.

As described herein, various embodiments can make use of information that is fed back from one or more steering selection platforms. For example, information can be fed back regarding success or failure of steering request(s). The information regarding success or failure of steering request(s) can be used in making future forecasts and/or in making future recommendations and/or instructions.

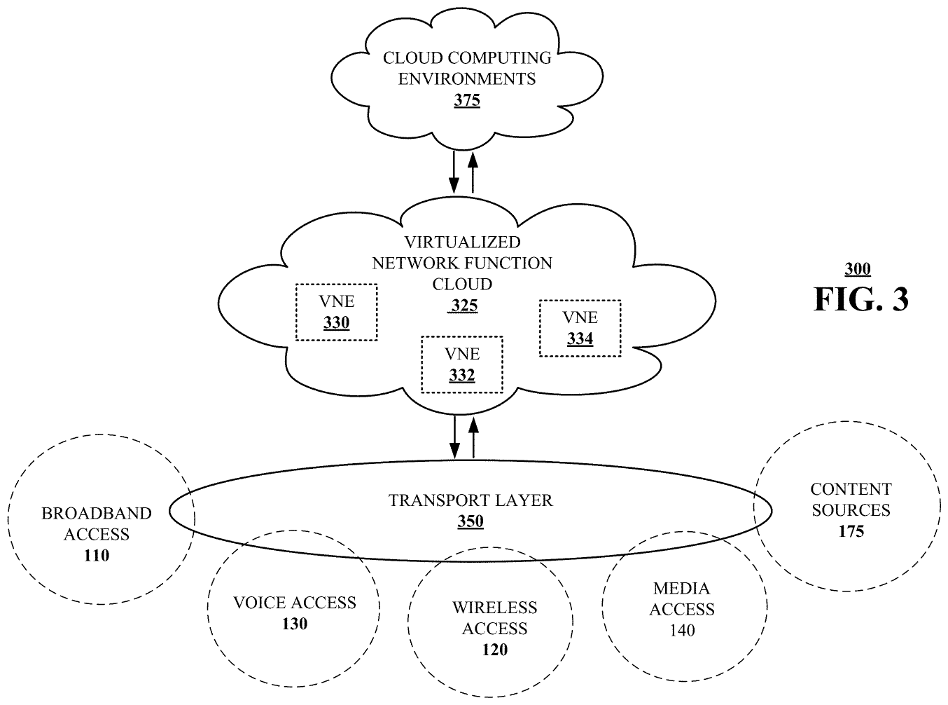

Referring now to FIG. 3, a block diagram 300 is shown illustrating an example, non-limiting embodiment of a virtualized communication network in accordance with various aspects described herein. In particular, a virtualized communication network is presented that can be used to implement some or all of the subsystems and functions of system 100 of FIG. 1, some or all of the subsystems and functions of system 200 of FIG. 2A, some or all of the subsystems and functions of system 240 of FIG. 2B, some or all of the subsystems and functions of system 260 of FIG. 2C, some or all of methods 2100, 2200 and/or 2300 (of respective FIGS. 2D, 2E, 2F), and/or some or all of the subsystems and functions of system 280 of FIG. 2G. For example, virtualized communication network 300 can facilitate in whole or in part steering each of a plurality of mobile communication devices (e.g., smartphones, tablets, laptop computers, cell phones, or any combination thereof) to a respective target roaming network that is selected from a plurality of candidate roaming networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

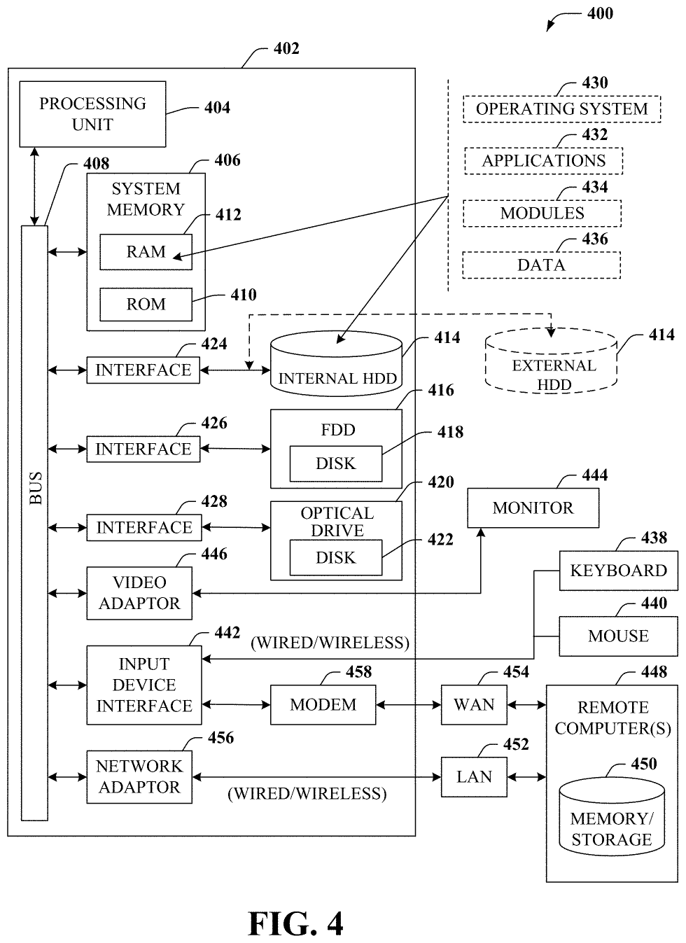

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In various examples, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. In various examples, computing environment 400 can facilitate in whole or in part steering each of a plurality of mobile communication devices (e.g., smartphones, tablets, laptop computers, cell phones, or any combination thereof) to a respective target roaming network that is selected from a plurality of candidate roaming networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

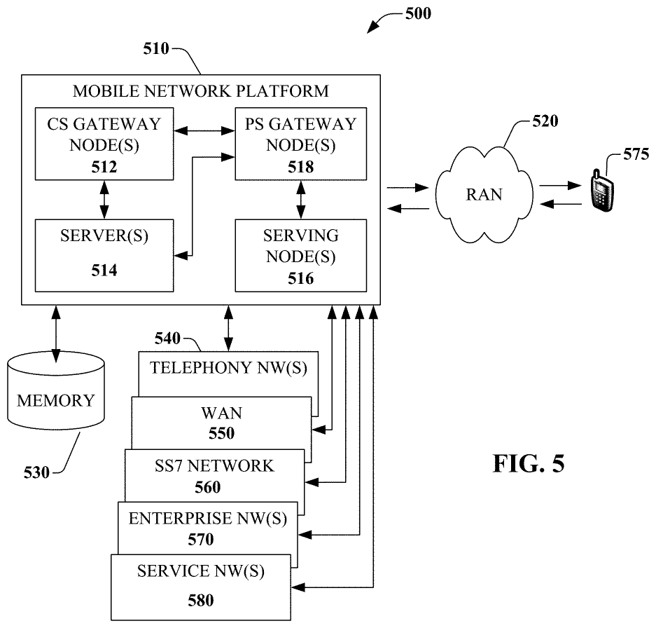

Turning now to FIG. 5, an embodiment 500 of a mobile network platform 510 is shown that is an example of network elements 150, 152, 154, 156, and/or VNEs 330, 332, 334, etc. In various examples, platform 510 can facilitate in whole or in part steering each of a plurality of mobile communication devices (e.g., smartphones, tablets, laptop computers, cell phones, or any combination thereof) to a respective target roaming network that is selected from a plurality of candidate roaming networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

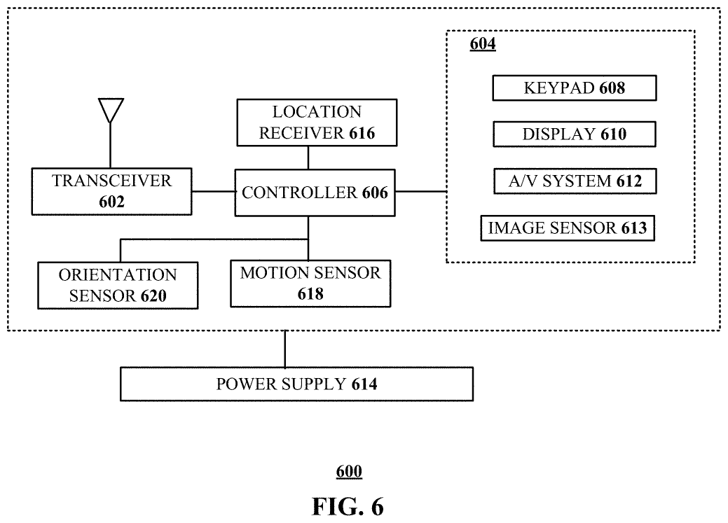

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part steering each of a plurality of mobile communication devices (e.g., smartphones, tablets, laptop computers, cell phones, or any combination thereof) to a respective target roaming network that is selected from a plurality of candidate roaming networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically steering each of a plurality of mobile communication devices (e.g., smartphones, tablets or the like) to a respective target roaming network that is selected from a plurality of candidate roaming networks) can employ various AI-based schemes for carrying out various embodiments thereof. Moreover, the classifier can be employed to determine a ranking or priority of each target and/or candidate roaming network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the candidate roaming network to select.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
obtaining, for each roaming agreement of a plurality of roaming agreements, respective roaming agreement data, each roaming agreement being between a wireless provider and a respective one of a plurality of wireless roaming providers, and all of the respective roaming agreement data comprising collective roaming agreement data;
obtaining, for each wireless subscriber of a plurality of wireless subscribers of the wireless provider, respective roaming usage data, the roaming usage data of each wireless subscriber comprising respective historical location information, and all of the respective roaming usage data comprising collective roaming usage data;
training, based upon the collective roaming usage data, a set of one or more models, the one or more models comprising one or more statistical models, one or more machine learning models, or any combination thereof, the one or more models being trained with multiple iterations of feedback loops, and the training resulting in one or more trained models;
estimating for each wireless subscriber, based upon the one or more trained models, respective projected location information for a future time, all of the respective projected location information comprising collective projected location information;
obtaining, for each of a plurality of wireless coverage areas of the plurality of wireless roaming providers, respective real-time network quality measurement data, all of the respective real-time network quality measurement data comprising collective real-time network quality measurement data;
modeling a plurality of scenarios for the future time based upon the collective roaming agreement data, based upon the collective real-time network quality measurement data and based upon the collective projected location information, each of the scenarios identifying for each of a plurality of projected future wireless roaming subscribers a respective one of the wireless roaming providers to communicate with at the future time, each of the scenarios further identifying a respective cost to the wireless provider, and the modeling being performed via use of a plurality of model constraints;
selecting from the scenarios, as a selected scenario, a scenario that has associated therewith a lowest total cost to the wireless provider also satisfying one or more of the plurality of model constraints based upon the collective roaming agreement data; and
sending recommendations, to a plurality of steering mechanisms, in order to implement the selected scenario.

2. The device of claim 1, wherein:
each of the projected future wireless roaming subscribers has associated therewith a respective piece of equipment; and
each of the recommendations causes one of the steering mechanisms to direct a particular piece of equipment to communicate with a particular one of the wireless roaming providers identified in the selected scenario for the projected future wireless roaming subscriber who is associated with that particular piece of equipment.

3. The device of claim 1, wherein:
the respective roaming agreement data corresponding to each roaming agreement is obtained via optical character recognition applied to each roaming agreement; and
the respective roaming agreement data corresponding to each roaming agreement comprises, for each of a plurality of different geographic locations at different time periods, a roaming cost to the wireless provider.

4. The device of claim 1, wherein the historical location information comprises, for each wireless subscriber, first information indicating a plurality of particular locations at a corresponding plurality of previous times.

5. The device of claim 4, wherein each of the particular locations comprises one of: a country; a territory; a state; a province; a political subdivision; a geographic area; or any combination thereof.

6. The device of claim 4, wherein the respective roaming usage data of each wireless subscriber further comprises second information indicating an amount of wireless bandwidth usage at each of the plurality of particular locations.

7. The device of claim 6, wherein the amount of the wireless bandwidth usage by each wireless subscriber at each of the particular locations comprises first usage attributable to voice communication, second usage attributable to data communication, or any combination thereof.

8. The device of claim 4, wherein the respective roaming usage data of each wireless subscriber further comprises second information indicating a type of wireless communication, and wherein the respective roaming usage data of each wireless subscriber that is obtained had been anonymized.

9. The device of claim 8, wherein each type of wireless communication comprises one of: enterprise communication; internet of things (IoT) communication; prepaid communication; consumer communication; or any combination thereof.

10. The device of claim 1, wherein:
the respective projected location information of each wireless subscriber comprises one of: a country; a territory; a state; a province; a political subdivision; a geographic area; or any first combination thereof; and
the future time comprises: a point in time; a plurality of points in time; a time range, a plurality of time ranges; a day; a date; a month; a year; or any second combination thereof.

11. The device of claim 1, wherein the operations further comprise:
monitoring the collective real-time network quality measurement data for steered subscribers based upon their latest respective locations; and
readjusting steering configurations to select one or more backup scenarios in event of a sudden drop in network quality.

12. The device of claim 1, wherein:
each of the projected future wireless roaming subscribers has associated therewith a respective piece of equipment that is used by the projected future wireless roaming subscriber to communicate with a respective base station of a respective one of the wireless roaming providers; and
each piece of equipment comprises one of: a smartphone; a tablet; a laptop computer; a cell phone, or any combination thereof.

13. The device of claim 1, wherein:
the training comprises automated parameter selection that is applied during the training for improved accuracy;
the satisfying the one or more of the plurality of model constraints based upon the collective roaming agreement data comprises satisfying all of the plurality of model constraints based upon the collective roaming agreement data; and
the selecting from the scenarios, as the selected scenario, the scenario that has associated therewith the lowest total cost to the wireless provider also satisfying the one or more of the plurality of model constraints based upon the collective roaming agreement data further comprises selecting from the scenarios, as the selected scenario, the scenario that has associated therewith the lowest total cost to the wireless provider also satisfying one or more subscriber network quality expectations.

14. A non-transitory machine-readable medium comprising executable instructions that, when executed by a processing system including a processor, facilitate performance of operations, the operations comprising:
obtaining, for each roaming agreement of a plurality of roaming agreements, corresponding roaming agreement data, each roaming agreement being between a provider of wireless services and a corresponding one of a plurality of providers of roaming services, and all of the corresponding roaming agreement data collectively comprising aggregated roaming agreement data;
obtaining, for each customer of a plurality of customers of the provider of wireless services, corresponding roaming data, the roaming data of each customer comprising corresponding location information indicative of one or more locations at which that customer had utilized corresponding wireless communication equipment, and all of the corresponding roaming data collectively comprising aggregated roaming data;
obtaining, for each of the providers of roaming services, corresponding real-time network performance data, all of the corresponding real-time network performance data collectively comprising aggregated real-time network performance data;
training, based upon the aggregated roaming data, a set of one or more models, the one or more models comprising one or more statistical models, one or more machine learning models, or any combination thereof, the one or more models being trained with multiple iterations of feedback loops, and the training resulting in one or more trained models;
predicting for each customer, based upon the one or more trained models, corresponding predicted location information for a future time, all of the corresponding predicted location information collectively comprising aggregated predicted location information;
modeling a plurality of scenarios for the future time based upon the aggregated roaming agreement data, based upon the aggregated predicted location information, and based upon the aggregated real-time network performance data, each of the scenarios identifying for each of a plurality of projected future roaming customers a corresponding one of the providers of roaming services to communicate with at the future time, each of the scenarios further identifying a corresponding total cost to the provider of wireless services, each of the scenarios further identifying an estimated network performance, and the modeling being performed via use of a plurality of model constraints;
determining, based upon the aggregated real-time network performance data, a threshold target network performance;
selecting from the scenarios, as a group of potential target scenarios, each scenario that meets the threshold target network performance;
selecting from the group of potential target scenarios, as a selected target scenario, a particular scenario that has associated therewith a particular cost to the provider of wireless services that satisfies a pre-determined cost constraint, also satisfying one or more of the plurality of model constraints based upon the aggregated roaming agreement data; and
sending recommendations, to a plurality of steering mechanisms, in order to implement the selected target scenario, the recommendations causing the steering mechanisms to direct a corresponding mobile device associated with each of the projected future roaming customers to communicate with a particular one of the providers of roaming services identified in the selected target scenario for that projected future roaming customer.

15. The non-transitory machine-readable medium of claim 14, wherein the aggregated real-time network performance data comprises a plurality of metrics.

16. The non-transitory machine-readable medium of claim 15, wherein each of the metrics comprises one of: bandwidth, latency, throughput, signal strength, or any combination thereof.

17. The non-transitory machine-readable medium of claim 14, wherein:
meeting the threshold target network performance comprises being at or above the threshold target network performance;
satisfying the pre-determined cost constraint comprises being a lowest cost to the provider of wireless services;
the training comprises automated parameter selection that is applied during the training for improved accuracy;
the satisfying the one or more of the plurality of model constraints based upon the aggregated roaming agreement data comprises satisfying all of the plurality of model constraints based upon the aggregated roaming agreement data;
the operations further comprise monitoring the aggregated real-time network performance data for steered subscribers based upon their latest corresponding locations; and
the operations further comprise readjusting steering configurations to select one or more backup scenarios in event of a sudden drop in network quality.

18. A method comprising:
obtaining by a processing system including a processor, for each wireless roaming agreement of a plurality of wireless roaming agreements, respective wireless roaming agreement data, each wireless roaming agreement being between a service provider and a respective one of a plurality of roaming providers, and all of the respective wireless roaming agreement data comprising aggregated wireless roaming agreement data;
obtaining by the processing system, for each subscriber of a plurality of subscribers of the service provider, respective wireless roaming usage data, the wireless roaming usage data of each subscriber comprising respective historical location information, and all of the respective wireless roaming usage data comprising aggregated wireless roaming usage data;
training by the processing system, based upon the aggregated wireless roaming usage data, a set of one or more models, the one or more models comprising one or more statistical models, one or more machine learning models, or any combination thereof, the one or more models being trained with multiple iterations of feedback loops, and the training resulting in one or more trained models;
estimating by the processing system for each subscriber, based upon the one or more trained models, respective estimated location information for a future time;
forming by the processing system a first set of future predicted wireless roaming subscribers, the first set of future predicted wireless roaming subscribers being based upon those subscribers whose respective estimated location information for the future time falls within a first region;
forming by the processing system a second set of future predicted wireless roaming subscribers, the second set of future predicted wireless roaming subscribers comprising those subscribers whose respective estimated location information for the future time falls within a second region, the second region being different from the first region;
modeling by the processing system a plurality of first scenarios for the future time based upon the aggregated wireless roaming agreement data and based upon the first set of future predicted wireless roaming subscribers, each of the first scenarios identifying for each of the future predicted wireless roaming subscribers of the first set of future predicted wireless roaming subscribers a respective one of the roaming providers to communicate with at the future time, each of the first scenarios further identifying a respective first cost to the service provider;
modeling by the processing system a plurality of second scenarios for the future time based upon the aggregated wireless roaming agreement data and based upon the second set of future predicted wireless roaming subscribers, each of the second scenarios identifying for each of the future predicted wireless roaming subscribers of the second set of future predicted wireless roaming subscribers a respective one of the roaming providers to communicate with at the future time, each of the second scenarios further identifying a respective second cost to the service provider;
selecting by the processing system from the first scenarios, as a first selected scenario, a first particular scenario that has associated therewith a lowest total cost to the service provider available in the first scenarios;
selecting by the processing system from the second scenarios, as a second selected scenario, a second particular scenario that has associated therewith a lowest total cost to the service provider available in the second scenarios;
sending by the processing system first recommendations, to at least one first steering mechanism, in order to implement the first selected scenario, the first recommendations causing the at least one first steering mechanism to direct respective equipment associated with each future predicted wireless roaming subscriber of the first set of future predicted wireless roaming subscribers to wirelessly communicate with a first particular one of the roaming providers identified in the first selected scenario for that future predicted wireless roaming subscriber; and
sending by the processing system second recommendations, to at least one second steering mechanism, in order to implement the second selected scenario, the second recommendations causing the at least one second steering mechanism to direct respective equipment associated with each future predicted wireless roaming subscriber of the second set of future predicted wireless roaming subscribers to wirelessly communicate with a second particular one of the roaming providers identified in the second selected scenario for that future predicted wireless roaming subscriber.

19. The method of claim 18, wherein:
the first region comprises one of: a first country; a first territory; a first state; a first province; a first political subdivision; a first geographic area; or any first combination thereof; and
the second region comprises one of: a second country; a second territory; a second state; a second province; a second political subdivision; a second geographic area; or any second combination thereof.

20. The method of claim 18, wherein the aggregated wireless roaming agreement data comprises:
for the first region at each of a plurality of first different time periods, a first time-dependent roaming cost to the service provider; and
for the second region at each of a plurality of second different time periods, a second time-dependent roaming cost to the service provider.
